(19) United States
(12) Patent Application Publication
(10) Pub. No.: US 2015/0339052 A1
(43) Pub. Date: Nov. 26, 2015

(54) METHOD AND APPARATUS FOR DISPLAYING SHORTCUT ON MOBILE TERMINAL AND STORAGE MEDIUM

(71) Applicant: Tencent Technology (Shenzhen) Co., Ltd., Shenzhen (CN)

(72) Inventors: Cancai YUAN, Shenzhen (CN); Quanhao XIAO, Shenzhen (CN)

(21) Appl. No.: 14/819,041

(22) Filed: Aug. 5, 2015

Related U.S. Application Data
(63) Continuation of application No. PCT/CN2013/087432, filed on Nov. 19, 2013.

(30) Foreign Application Priority Data
Feb. 7, 2013 (CN) 201310049653.4

(51) Int. Cl. G06F 3/0488; G06F 3/0481

(52) U.S. Cl. CPC G06F 3/04883; G06F 3/04817

(57) ABSTRACT

A method and an apparatus for displaying a shortcut on a mobile terminal and a storage medium are provided. The method includes: acquiring a touch signal generated at a system status bar on a screen of a mobile terminal; and opening a shortcut display window in a case that the touch signal is acquired, and displaying a pre-selected shortcut of an application program in the shortcut display window. By using the above solution, efficiency of searching for a shortcut of an application program installed on a mobile terminal can be improved.

### CROSS-REFERENCE TO RELATED APPLICATIONS

This application is a continuation of International Application No. PCT/CN2013/087432 filed on Nov. 19, 2013 and entitled “DISPLAYING METHOD, DEVICE AND STORAGE MEDIUM OF MOBILE TERMINAL SHORTCUTS”, which claims priority to Chinese Patent Application No. 201310049653.4, entitled “METHOD AND APPARATUS FOR DISPLAYING SHORTCUT ON MOBILE TERMINAL” filed by Tencent Technology (Shenzhen) Co., Ltd. on Feb. 7, 2013, which are incorporated by reference in their entireties.

### FIELD OF THE TECHNOLOGY

The present disclosure relates to the field of computers, and in particular, to a method and an apparatus for displaying a shortcut on a mobile terminal and a storage medium.

### BACKGROUND OF THE DISCLOSURE

With the rapid development of mobile terminal technologies, a wider and wider variety of applications with rich functionality are installed on the mobile terminals. The number of applications installed on a mobile terminal owned by a user keeps growing. Shortcuts of applications are generally displayed on a desktop of the mobile terminal in form of icons, and the icons of the shortcuts generally have a same size.

A current mainstream mobile terminal is used as an example. There are a large number of icons of shortcuts, while only a limited number of shortcuts of applications can be displayed within a screen range of the mobile terminal. Therefore, a pagination-display is usually used to display shortcuts of all applications, and there are usually a lot of pages to be displayed.

There are a large number of shortcuts of applications in a mobile terminal, the shortcuts are displayed in multiple pages, and the shortcuts have a same display size; hence, it is inconvenient for a user to search for a shortcut quickly and the efficiency of searching for a shortcut by the user is relatively low.

### SUMMARY

Embodiments of the present disclosure provide a method and an apparatus for displaying a shortcut on a mobile terminal and a storage medium, so as to improve efficiency of searching for a shortcut of an application on a mobile terminal. In the embodiments of the present disclosure, the following technical solutions are provided.

An aspect provides a method for displaying a shortcut on a mobile terminal, including:

providing a system status bar displayed on a screen of the mobile terminal;

acquiring a touch signal generated at the system status bar; and

opening a shortcut display window in a case that the touch signal is acquired, and displaying a pre-selected shortcut of an application in the shortcut display window.

Another aspect provides an apparatus for displaying a shortcut on a mobile terminal, where the apparatus includes:

an acquiring module, configured to provide a system status bar displayed on a screen of the mobile terminal, and acquire a touch signal generated at the system status bar; and

a display module, configured to open a shortcut display window in a case that the acquiring module acquires the touch signal, and display a pre-selected shortcut of an application in the shortcut display window.

Still another aspect provides a storage medium including computer executable instructions, and the computer executable instructions, when being executed by a processor of a computer, enables the processor to:

provide a system status bar displayed on a screen of the mobile terminal;

acquire a touch signal generated at the system status bar; and

open a shortcut display window in a case that the touch signal is acquired, and display a pre-selected shortcut of an application in the shortcut display window.

In the embodiments of the present disclosure, in a case that a touch signal generated at a system status bar on a screen of a mobile terminal is acquired, a shortcut display window is opened, and a pre-selected shortcut of an application is displayed in the shortcut display window. In this way, shortcuts of some frequently-used applications may be displayed together in this shortcut display window, thereby improving efficiency of searching for a shortcut of an application.

### BRIEF DESCRIPTION OF THE DRAWINGS

To describe technical solutions in embodiments of the present disclosure more clearly, the following briefly introduces the accompanying drawings to be used in describing the embodiments. Apparently, the accompanying drawings in the following description are merely for describing some embodiments of the present disclosure, and a person of ordinary skill in the art may still make modification and replacement to these accompanying drawings without creative efforts.

FIG. 1 illustrates a flowchart of a method for displaying a shortcut on a mobile terminal according to various embodiments of the present disclosure;

FIG. 2 illustrates a schematic diagram of a system status bar and a shortcut display window according to various embodiments of the present disclosure; and

FIG. 3 illustrates a schematic structural diagram of an apparatus for displaying a shortcut on a mobile terminal according to various embodiments of the present disclosure.

### DESCRIPTION OF EMBODIMENTS

To make the technical solutions and advantages of the present disclosure clearer, the implementation manners of the present disclosure are further described in detail below with reference to the accompanying drawings.

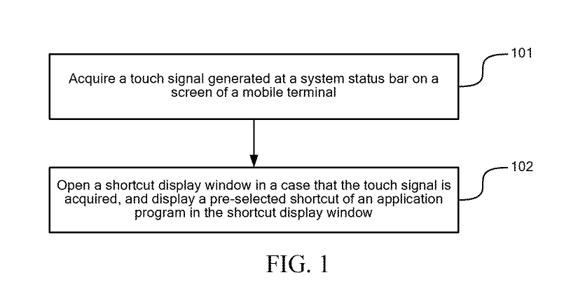

This embodiment of the present disclosure provides a method for displaying a shortcut on a mobile terminal. The method may be implemented by an apparatus for displaying a shortcut on a mobile terminal. The apparatus may be implemented by software or hardware or the combination thereof, and is arranged in an electronic device that can perform data communication with the mobile terminal and has a memory and a processor. The memory includes storage medium, which may further include memory modules, e.g., a read-only memory (ROM), a random access memory (RAM), and flash memory modules, and mass storages, e.g., a CD-ROM, a U-disk, a removable hard disk, etc, which are all non-transitory storage mediums that store program modules for implementing various processes, when executed by the processors. In this embodiment of the present disclosure, this apparatus may be configured in the mobile terminal. As shown in FIG. 1, a processing process of the method may include the following steps 101-102.

Step 101, acquire a touch signal at a system status bar on a screen of a mobile terminal.

Step 102, open a shortcut display window in a case of acquiring the touch signal and to display a pre-selected shortcut of an application in the shortcut display window.

In this embodiment of the present disclosure, once a touch signal at the system status bar on the screen of the mobile terminal is acquired, a shortcut display window is opened, and a pre-selected shortcut of an application is displayed in the shortcut display window. In this way, shortcuts of some frequently-used applications may be displayed together in this shortcut display window, thereby improving efficiency of searching for a shortcut of an application.

This embodiment of the present disclosure provides a method for displaying a shortcut on a mobile terminal. The method may be executed by a mobile terminal. A processing process shown in FIG. 1 is illustrated in detail below with reference to a specific implementation process, and specific content is as follows.

In step 101, a touch signal at a system status bar on a screen of a mobile terminal is acquired.

The system status bar is a bar-shaped area at the top of a system desktop of the mobile terminal, and information such as time, battery level, and signal strength is displayed in the system status bar.

In this embodiment of the present disclosure, a sensor disposed under the screen of the mobile terminal may detect a touch performed on a screen surface of the mobile terminal and send a corresponding touch signal to a processor of the mobile terminal.

In a specific implementation manner of this embodiment of the present disclosure, acquiring a touch signal at a system status bar may include: receiving a tap operation at the system status bar, and generating a tap touch signal according to the tap operation. After the touch signal is generated, no displacement occurs until the touch signal disappears, and in this case, this touch signal may be referred to as a tap touch signal. Certainly, the “no displacement occurs” herein refers to that a displacement beyond a certain range of allowable errors does not occur (that is, a relatively small displacement may be ignored). A user operation for generating a tap touch signal may be that, a finger of a user contacts a screen and then leaves the screen and the finger does not slide during contacting the screen. A tap position of the tap operation is within a range of the system status bar, that is, a corresponding user operation is tapping the system status bar.

In another specific implementation manner of this embodiment of the present disclosure, the acquiring a touch signal at the system status bar may include: receiving a slide operation at the system status bar, and generating a slide touch signal according to the slide operation. A starting point of the slide operation is within a range of the system status bar and a displacement value of the slide operation in a horizontal-axis direction reaches a preset threshold. After the touch signal is generated, a displacement occurs and the displacement exceeds a preset range, and in this case, the touch signal may be referred to as a slide touch signal. A user operation for generating the slide touch signal may be that a finger of a user touches the screen and then moves while keeping in contact with the screen. The user operation corresponding to the acquired slide touch signal may be that the user first taps and presses the system status bar, and then moves in a horizontal-axis direction by a distance of the threshold and leaves the system status bar. A displacement value of the slide operation in the horizontal-axis direction reaches a preset threshold means that, a displacement of the slide operation in the vertical-axis direction (a difference between vertical coordinates of the starting point and an ending point of the slide operation) may be random, but the value of a displacement in the horizontal-axis direction (a difference between horizontal coordinates of the starting point and an ending point of the slide operation) is equal to or greater than the threshold.

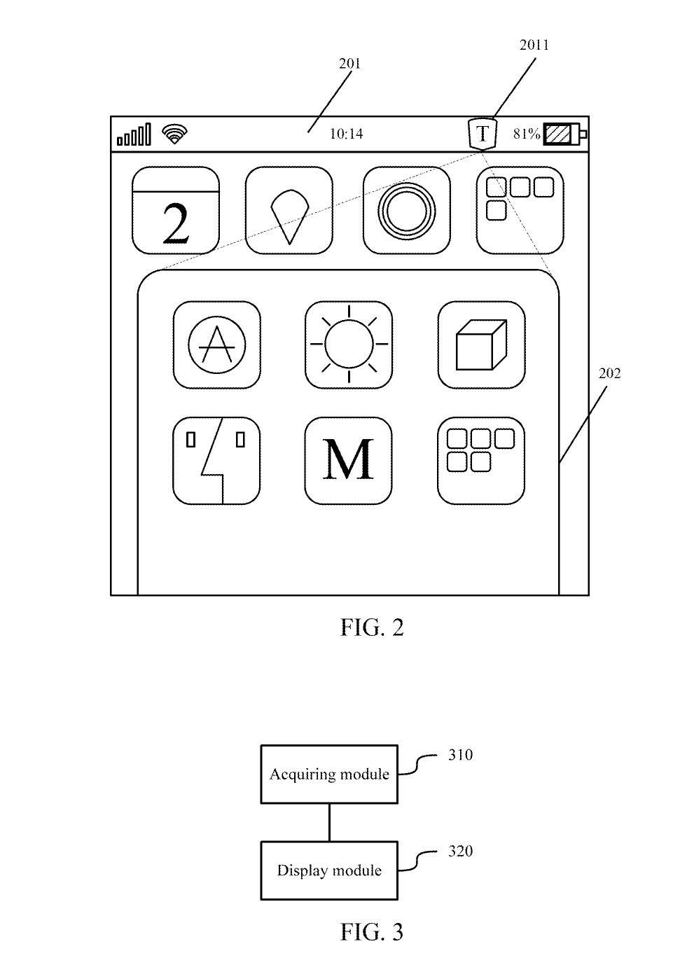

Further, as shown in FIG. 2, a triggering button 2011 may be set in a system status bar 201. In a case that the acquired touch signal at the system status bar is a tap touch signal, a tap position of the tap touch signal is a position of the triggering button. In a case that the acquired touch signal at the system status bar is a slide touch signal, a position of a starting point of the slide touch signal is a position of the triggering button. Therefore, the receiving a tap operation at the system status bar specifically includes receiving a tap operation at a position where the triggering button is located in the system status bar; and the receiving a slide operation at the system status bar specifically includes receiving a slide operation of which a starting point is a position where the triggering button is located in the system status bar. Further, the method according to this embodiment of the present disclosure may be implemented by means of data interaction between a mobile terminal and a target application installed on the mobile terminal. The foregoing triggering button may specifically be an application icon of the target application, and the application icon may be any preset icon in the target application. After detecting that installation of the target application or execution of the target application is accomplished, the mobile terminal may display the application icon of the target application in the system status bar. A specific display process may be: receiving an icon setting request sent by the target application, where the icon setting request carries display data and position information of the application icon; and displaying, according to the display data of the application icon, the application icon of the target application at a position, which corresponds to the position information, in the system status bar.

The icon setting request may be triggered to be sent after installation or execution of the target application is accomplished. The position information may be coordinates of a position. The display data of the application icon may be picture data of the application icon.

In step 102, a shortcut display window (reference may be made to a shortcut display window 202 in FIG. 2) is opened in a case that the touch signal is acquired, and display a pre-selected shortcut of an application in the shortcut display window.

The shortcut display window is a window for displaying shortcuts of applications together. The shortcut display window may be presented in a manner of a translucent floating layer, that is, the shortcut display window floats above a desktop and a display page in the shortcut display window is translucent. The pre-selected application herein may be any one or more applications installed on the mobile terminal.

In this embodiment of the present disclosure, a display page that is to be displayed in the shortcut display window may be generated and stored in advance. The display page herein includes a shortcut of one or more pre-selected applications. In this case, a display process may include: displaying the stored display page in the shortcut display window. After a running interface of an application is entered and during a process of running the application, the system status bar is still visible, and a user may still perform an operation on the system status bar at this time. Therefore, in this embodiment of the present disclosure, the shortcut display window is opened by using a triggering operation at the system status bar, and the opening of the shortcut display window becomes more convenient and faster.

The shortcut (that is, the pre-selected shortcut) displayed in the shortcut display window may be selected by a system automatically. Specifically, the system may display, according to use frequencies of various applications, shortcuts of the applications in the shortcut display window, for example, display a shortcut of an application which is relatively frequently-used in the shortcut display window.

Alternatively, the shortcut displayed in the shortcut display window may be set in the following manner: receiving a shortcut display setting request, where the shortcut display setting request carries a shortcut identifier; and generating a display page in the shortcut display window according to the shortcut identifier, and storing the generated display page, where a shortcut corresponding to the shortcut identifier is set in the display page.

Specifically, each shortcut may be set with a shortcut identifier, and a mobile terminal may pre-store a mapping relationship between each shortcut and each shortcut identifier. After a shortcut display setting request is received, each shortcut corresponding to a shortcut identifier carried in the request may be set on the foregoing display page.

Further, the shortcut display setting request may further carry arrangement order information corresponding to the shortcut identifier. Each shortcut identifier may correspond to one piece of arrangement order information. In this case, when shortcuts are set on the foregoing display page, the respective shortcuts may be arranged according to the corresponding arrangement order information. The arrangement order information may be sequence numbers, and the shortcuts may be arranged and displayed according to the sequence numbers.

In a specific implementation manner of this embodiment of the present disclosure, the method may further include: providing a setting page which is configured to set the shortcut displayed in the shortcut display window. In the setting page, icons of all applications installed on the mobile terminal may be displayed and a check box may be set for each icon. A user may check an icon which is not checked, by taping the icon, and may uncheck an icon which is already checked, by taping the icon. In the setting page, an icon which is already checked may be arranged at a relative preceding position automatically. In addition, the user may long press icons which are already checked and then drag each of the icons to a corresponding position, thereby arranging the checked icons. In this case, after the user sets icons of applications by using the setting page, the mobile terminal may determine a corresponding shortcut identifier according to a checked icon on the setting page and determine corresponding arrangement order information according to a sequence number of the checked icon. According to the determined shortcut identifier and the determined arrangement order information, the mobile terminal may further generate a shortcut display setting request and send the shortcut display setting request to a processor of the mobile terminal, so as to generate a display page in the shortcut display window according to the shortcut display setting request.

In step 102, a pre-stored function setting key may further be displayed in the shortcut display window. The function setting key is a shortcut setting button that is used for executing some software or hardware function of a systematic application, for example, a Bluetooth switch, an airplane mode switch, and a positioning function switch. The function setting key is set in the shortcut display window, which can facilitate setting of a systematic function.

In this embodiment of the present disclosure, in a case that a touch signal at a system status bar on a screen of a mobile terminal is acquired, a shortcut display window is opened, and a pre-selected shortcut of an application is displayed in the shortcut display window. In this way, shortcuts of some frequently-used applications may be displayed together in this shortcut display window, thereby improving efficiency of searching for a shortcut of an application.

Based on a same technical concept, this embodiment of the present disclosure further provides an apparatus for displaying a shortcut on a mobile terminal. As shown in FIG. 3, the apparatus includes:

an acquiring module 310, configured to acquire a touch signal at a system status bar on a screen of a mobile terminal; and

a display module 320, configured to open a shortcut display window in a case that the acquiring module 310 acquires the touch signal, and display a pre-selected shortcut of an application in the shortcut display window.

Further, the acquiring module 310 is specifically configured to receive a tap operation at the system status bar, and generate a tap touch signal according to the tap operation; or

receive a slide operation at the system status bar, and generate a slide touch signal according to the slide operation, where the displacement value of the slide operation in a horizontal-axis direction reaches a preset threshold.

Further, in a case that the acquiring module 310 is configured to receive a tap operation at the system status bar, the acquiring module 310 is specifically configured to receive a tap operation at a position where a triggering button is located in the system status bar.

In a case that the acquiring module 310 is configured to receive a slide operation at the system status bar, the acquiring module 310 is specifically configured to receive a slide operation of which a starting point is a position where a triggering button is located in the system status bar. Specifically, the triggering button may be an application icon of a target application.

The apparatus further includes a setting module, which is configured to:

receive an icon setting request sent by a target application, where the icon setting request carries display data and position information of the application icon; and

display, according to the display data of the application icon, the application icon of the target application at a position, which corresponds to the position information, in the system status bar.

Further, the display module 320 is further configured to pre-select a shortcut of an application, by receiving a shortcut display setting request carrying a shortcut identifier; generating a display page in the shortcut display window according to the shortcut identifier; and storing the generated display page, where a shortcut corresponding to the shortcut identifier is set in the display page.

In a case that the display module 320 is configured to display a pre-selected shortcut of an application in the shortcut display window, the display module 320 is configured to display the stored display page in the shortcut display window.

Further, the shortcut display setting request further carries arrangement order information corresponding to the shortcut identifier.

The display module 320 is further configured to arrange the shortcut in the display page according to the arrangement order information.

The display module 320 may be further configured to:

display a pre-stored function setting key in the shortcut display window.

Further, the shortcut display window is displayed in a manner of a translucent floating layer.

In this embodiment of the present disclosure, in a case that a touch signal at a system status bar on a screen of a mobile terminal is acquired, a shortcut display window is opened, and a pre-selected shortcut of an application is displayed in the shortcut display window. In this way, shortcuts of some frequently-used applications may be displayed together in this shortcut display window, thereby improving efficiency of searching for a shortcut of an application.

It should be noted that the above functional modules are only exemplary for describing shortcut displaying performed by the apparatus for displaying a shortcut on a mobile terminal provided by the foregoing embodiment. In actual, the functions may be achieved by different functional modules according to needs, that is, the internal structure of the apparatus is divided into different functional modules to complete all or some of the above described functions. In addition, the apparatus for displaying a shortcut on a mobile terminal provided by the foregoing embodiment is based on the same concept as the method for displaying a shortcut on a mobile terminal in the foregoing embodiments. For the specific implementation process of the apparatus, reference can be made to the method embodiments, and the details are not repeated herein.

An embodiment of the present disclosure further provides a storage medium. The storage medium may be a non-transitory computer readable storage medium that stores computer executable instructions. The computer executable instructions are used for executing a method for displaying a shortcut on a mobile terminal. The method includes the following steps:

acquiring a touch signal at a system status bar on a screen of a mobile terminal; and

opening a shortcut display window in a case that the touch signal is acquired, and displaying a pre-selected shortcut of an application in the shortcut display window.

The sequential numbers of the foregoing embodiments of the present disclosure are merely an expression form for the convenience of description, and do not imply the preference among the embodiments.

A person of ordinary skill in the art may understand that all or some of the steps of the foregoing embodiments may be implemented by using hardware, or may be implemented by a program instructing relevant hardware.

The foregoing descriptions are merely preferred embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A method for displaying a shortcut on a mobile terminal, the method comprising a processor performing the following on the mobile terminal:
providing a system status bar displayed on a screen of the mobile terminal;
acquiring a touch signal generated at the system status bar;
opening a shortcut display window when the touch signal is acquired; and
displaying a pre-selected shortcut of an application in the shortcut display window.

2. The method according to claim 1, wherein the acquiring of the touch signal generated at the system status bar, comprises:
receiving a tap operation performed at the system status bar, and generating a tap touch signal according to the tap operation.

3. The method according to claim 1, wherein the acquiring of the touch signal generated at the system status bar, comprises:
receiving a slide operation performed at the system status bar, and generating a slide touch signal according to the slide operation, wherein a displacement value of the slide operation in a horizontal-axis direction reaches a preset threshold.

4. The method according to claim 3, wherein the receiving of the tap operation performed at the system status bar, comprises:
receiving a tap operation performed at a position where a triggering button is located in the system status bar.

5. The method according to claim 4, wherein the triggering button is an application icon of a target application; and
the application icon is set in the system status bar by:
receiving an icon setting request sent by the target application, wherein the icon setting request carries display data and position information of the application icon; and
displaying, according to the display data of the application icon, the application icon of the target application at a position, which corresponds to the position information, in the system status bar.

6. The method according to claim 3, wherein the receiving of the slide operation performed at the system status bar, comprises: receiving a slide operation of which a starting point is a position where a triggering button is located in the system status bar.

7. The method according to claim 6, wherein the triggering button is an application icon of a target application; and
the application icon is set in the system status bar by:
receiving an icon setting request sent by the target application, wherein the icon setting request carries display data and position information of the application icon; and
displaying, according to the display data of the application icon, the application icon of the target application at a position, which corresponds to the position information, in the system status bar.

8. The method according to claim 1, wherein a shortcut of an application is pre-selected by:
receiving a shortcut display setting request, wherein the shortcut display setting request carries a shortcut identifier,
generating a display page in the shortcut display window according to the shortcut identifier; and
storing the generated display page; wherein a shortcut corresponding to the shortcut identifier is set in the display page; and
the displaying of the pre-selected shortcut of an application in the shortcut display window, comprises: displaying the stored display page in the shortcut display window.

9. The method according to claim 8, wherein the shortcut display setting request further carries arrangement order information corresponding to the shortcut identifier; and
the method further comprises: arranging the shortcut in the display page according to the arrangement order information.

10. The method according to claim 1, further comprising:
displaying a pre-stored function setting key in the shortcut display window.

11. The method according to claim 1, wherein the shortcut display window is displayed in a manner of a translucent floating layer.

12. An apparatus for displaying a shortcut on a mobile terminal, comprising at least a processor coupled to a memory which stores executable instruction codes, wherein the instruction codes when executed by the processor, configures the mobile terminal to:
provide a system status bar displayed on a screen of the mobile terminal, and acquire a touch signal generated at the system status bar; and
open a shortcut display window when the touch signal has been acquired, and display a pre-selected shortcut of an application in the shortcut display window.

13. The apparatus according to claim 12, wherein the mobile terminal is configured to:
receive a tap operation performed at the system status bar, and generate a tap touch signal according to the tap operation.

14. The apparatus according to claim 13, wherein in case that the mobile terminal receives a tap operation performed at the system status bar, the configured to receive a tap operation performed at a position where a triggering button is located in the system status bar.

15. The apparatus according to claim 14, wherein the triggering button is an application icon of a target application; and the mobile terminal is further configured to:
receive an icon setting request sent by the target application, wherein the icon setting request carries display data and position information of the application icon; and
display, according to the display data of the application icon, the application icon of the target application at a position, which corresponds to the position information, in the system status bar.

16. The apparatus according to claim 14, wherein the mobile terminal is configured to:
receive a slide operation performed at the system status bar, and generate a slide touch signal according to the slide operation, wherein the displacement value of the slide operation in a horizontal-axis direction reaches a preset threshold.

17. The apparatus according to claim 16, wherein in case that the mobile terminal receives a slide operation performed at the system status bar, the acquiring module is configured to receive a slide operation of which a starting point is a position where a triggering button is located in the system status bar.

18. The apparatus according to claim 17, wherein the triggering button is an application icon of a target application; and
the mobile terminal is further configured to:
receive an icon setting request sent by the target application, wherein the icon setting request carries display data and position information of the application icon; and
display, according to the display data of the application icon, the application icon of the target application at a position, which corresponds to the position information, in the system status bar.

19. The apparatus according to claim 12, wherein the mobile terminal is further configured to pre-select a shortcut of an application by:
receiving a shortcut display setting request, wherein the shortcut display setting request carries a shortcut identifier,
generating a display page in the shortcut display window according to the shortcut identifier; and
storing the generated display page; wherein a shortcut corresponding to the shortcut identifier is set in the display page; and
wherein the mobile terminal displays the pre-selected shortcut of the application in the shortcut display window by displaying the stored display page in the shortcut display window.

20. The apparatus according to claim 19, wherein the shortcut display setting request further carries arrangement order information corresponding to the shortcut identifier; and
the mobile terminal is further configured to arrange the shortcut in the display page according to the arrangement order information.

21. A non-transitory storage medium comprising computer executable instructions, wherein the computer executable instructions when being executed by a processor, cause a mobile terminal to:
provide a system status bar displayed on a screen of the mobile terminal;
acquire a touch signal generated at the system status bar; and
open a shortcut display window when the touch signal is acquired, and display a pre-selected shortcut of an application in the shortcut display window.
